(19) United States
(12) Patent Application Publication
(10) Pub. No.: US 2025/0360616 A1
(43) Pub. Date: Nov. 27, 2025

(54) TIME-OF-FLIGHT SENSORS FOR WEARABLE ROBOTIC TRAINING DEVICES

(71) Applicant: Lemi, Inc., Cupertino, CA (US)

(72) Inventors: Clayton Haight, Mountain View, CA (US); Haichuan Che, Mountain View, CA (US); Seungho Yang, Sunnyvale, CA (US); Litian Liang, Mountain View, CA (US); Zhanghan Yu, Menlo Park, CA (US); Camilla Xie Guo, Portola Valley, CA (US); Cheng Chi, Mountain View, CA (US); Zihao Zhao, Cupertino, CA (US)

(21) Appl. No.: 19/214,795

(22) Filed: May 21, 2025

Related U.S. Application Data
(60) Provisional application No. 63/650,317, filed on May 21, 2024.
(60) Provisional application No. 63/715,815, filed on Nov. 4, 2024.
(60) Provisional application No. 63/715,854, filed on Nov. 4, 2024.
(60) Provisional application No. 63/715,878, filed on Nov. 4, 2024.
(60) Provisional application No. 63/715,893, filed on Nov. 4, 2024.

(51) Int. Cl. B25J 9/16; B25J 13/02

(52) U.S. Cl. CPC B25J 9/163; B25J 9/1697; B25J 13/02

(57) ABSTRACT

Technology disclosed herein includes a wearable data collection device for training robotic systems. In an implementation, a wearable data collection device includes a hand element configured to receive a user's hand, multiple finger elements extending from the hand element, and joints coupling the finger elements to the hand element. The finger elements are constrained to movements that match capabilities of a robotic counterpart device. Multiple sensors mounted on the device capture pressure, position, visual, proximity, and acoustic data during recording sessions. The device may integrate with position tracking technologies such as mobile devices or augmented reality headsets. Data collected through the wearable device serves as training input for a neural network that controls the robotic counterpart.

### CROSS-REFERENCE TO RELATED APPLICATIONS

This application claims priority to U.S. Provisional Application No. 63/650,317 titled IN-HAND DATA COLLECTION EXOSKELETON FOR TRAINING ROBOTICS MODELS, filed May 21, 2024, U.S. Provisional Application No. 63/715,815 titled APPLICATION FOR PATENT, filed Nov. 4, 2024, U.S. Provisional Application No. 63/715,854 titled APPLICATION FOR PATENT, filed Nov. 4, 2024, U.S. Provisional Application No. 63/715,878 titled APPLICATION FOR PATENT, filed Nov. 4, 2024, and U.S. Provisional Application No. 63/715,893 titled APPLICATION FOR PATENT, filed Nov. 4, 2024, which are incorporated herein by reference in their entirety for all purposes.

### TECHNICAL FIELD

Aspects of the disclosure relate to robotic systems and, more particularly, to wearable data collection devices for capturing training data to control robotic manipulation systems.

### BACKGROUND

In the field of robotics, the ability to grasp and manipulate objects with precision and dexterity represents a fundamental challenge. Robotic manipulation systems are deployed across various industries including manufacturing, logistics, healthcare, and service sectors, wherein they must interact with objects of diverse shapes, sizes, materials, and physical properties. Traditional approaches to robotic manipulation have relied on hard-coded control algorithms, which while effective for structured environments, often struggle with novel objects, environmental variability, and complex manipulation sequences.

Machine learning techniques, particularly deep learning and reinforcement learning, have emerged as promising alternatives for developing more adaptive robotic manipulation capabilities. These approaches enable robots to learn manipulation skills from data rather than relying solely on explicit programming. However, collecting sufficient high-quality training data poses significant challenges, with conventional methodologies like teleoperation systems and demonstration approaches facing substantial limitations in terms of intuitiveness, data quality, transfer fidelity, and scalability.

The gap between human manipulation capabilities and robotic performance remains substantial. Humans possess exceptional dexterity, tactile sensing, and intuitive understanding of physical interactions that allow them to easily manipulate objects. Existing sensor technologies for robotic manipulation include force/torque sensors, tactile arrays, proximity sensors, vision systems, and the like, each providing partial information about manipulation actions. Despite advances in hardware, sensing technologies, and learning algorithms, developing robotic systems that approach human-level manipulation capabilities continues to face significant technical hurdles in data collection, sensor integration, and generalization across diverse tasks.

It is with respect to this general technical environment that aspects of the present technology disclosed herein have been contemplated. Furthermore, although a general environment has been discussed, it should be understood that the examples described herein should not be limited to the general environment identified in the background.

### SUMMARY

Various embodiments of the present technology generally relate to wearable data collection devices for robotic system training. More specifically, the technology disclosed herein includes a wearable exoskeleton device that captures human hand movements, forces, and environmental interactions while manipulating objects. The wearable device includes multiple finger elements with constrained degrees of freedom designed to mimic the capabilities of a robotic counterpart device, integrated sensors that collect multimodal data during manipulation tasks, and interfaces for position tracking and data transmission. This integrated system enables the collection of comprehensive training datasets that capture key aspects of human manipulation strategies for transfer to robotic systems.

In exemplary embodiments, the wearable data collection device incorporates pressure sensors, position sensors, cameras, time-of-flight sensors, piezoelectric microphones, and possibly additional sensors to capture multidimensional data about manipulation tasks. The device may be paired with position tracking technologies including mobile devices and/or augmented reality headsets to record spatial movements throughout the manipulation process. The collected multimodal sensor data serves as training input for a neural network model that learns to map sensory inputs to appropriate control outputs for the robotic counterpart device. This approach enables more intuitive and efficient data collection compared to traditional robotic programming or teleoperation methods, facilitating the development of more capable and adaptable robotic manipulation systems.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates a training data collection environment in accordance with some embodiments of the present technology.

FIG. 2 is a flowchart illustrating a series of steps performed by a wearable data collection device in accordance with some embodiments of the present technology.

FIGS. 3A-31 illustrate an example of a wearable data collection device in accordance with some embodiments of the present technology.

FIG. 4 is a flowchart illustrating a series of steps for training and deploying a robotic control model in accordance with some embodiments of the present technology.

FIG. 5 is a flowchart illustrating a series of steps performed by a wearable data collection device in accordance with some embodiments of the present technology.

FIG. 6 is a flowchart illustrating a series of steps performed by a wearable data collection device in accordance with some embodiments of the present technology.

FIG. 7 is a flowchart illustrating a series of steps performed by a wearable data collection device in accordance with some embodiments of the present technology.

FIG. 8 is a flowchart illustrating a series of steps performed by a wearable data collection device in accordance with some embodiments of the present technology.

FIG. 9 illustrates a computing system suitable for implementing the various operational environments, architectures, processes, scenarios, and sequences discussed below with respect to the other Figures.

### DETAILED DESCRIPTION

The present technology generally pertains to training machine learning models to operate robotic devices. The technology disclosed herein includes a wearable data collection device for training neural networks that operate a robotic counterpart to the wearable data collection device. The wearable data collection device includes a hand element configured to receive a hand of a user and a plurality of finger elements extending from the hand element. The finger elements are coupled to the hand element by a plurality of joints that enable movement of the finger elements relative to the hand element within a constrained range of motion. This constrained range of motion corresponds to movement capabilities of a robotic counterpart device, such that the movements performed while wearing the device can be effectively reproduced by the robotic system. The wearable data collection device further includes a plurality of sensors mounted on the device that capture sensor data during recording sessions, and a processing circuit operatively coupled to the sensors that collects and transmits the sensor data for training purposes.

In various embodiments, the wearable data collection device may be used in conjunction with different position-tracking mechanisms to record spatial movement data. These tracking mechanisms include but are not limited to a mobile device (e.g., smartphone) mounted on the wearable data collection device and/or an augmented reality (AR) headset worn by the user, with a controller associated with the AR headset secured to the wearable data collection device. Both approaches enable tracking of the position and orientation of the wearable data collection device during recording sessions, providing spatial data for training the neural network that will control the robotic counterpart.

The plurality of sensors mounted on the wearable data collection device may include various types of sensors for capturing different aspects of the manipulation tasks. In some embodiments, the sensors include at least one pressure sensor positioned on each of the plurality of finger elements to detect forces applied during object manipulation. Additionally, the wearable data collection device may include at least one position sensor at each of the plurality of joints configured to capture angle data, providing information about the configuration of the finger elements relative to the hand element. The wearable data collection device may also include at least one camera mounted on the device to capture visual data from the perspective of the hand during manipulation tasks.

In some embodiments, the wearable data collection device includes one or more time-of-flight (ToF) sensors mounted on the device. Each time-of-flight sensor comprises a light emitter configured to emit light, a grid of light receivers configured to detect reflections of the light, and circuitry configured to collect time-of-flight data representing the time between emission of the light and detection of the reflections at the grid of light receivers. These time-of-flight sensors provide precise distance measurements to objects being manipulated, enhancing the device's ability to generate accurate spatial awareness data. In certain configurations, the wearable data collection device may include multiple time-of-flight sensors positioned at different locations on the device, with each time-of-flight sensor positioned proximate to a respective camera, enabling easily-correlated visual and depth information.

Another sensor type included in some embodiments of the wearable data collection device is at least one piezoelectric microphones mounted on the device. Each piezoelectric microphone is configured to detect vibrations caused by contact between the wearable data collection device and an object and convert these vibrations into electrical signals representing contact sound data. In certain configurations, the wearable data collection device may include multiple piezoelectric microphones mounted on different finger elements, such as a first piezoelectric microphone mounted on a back surface of an index finger element and a second piezoelectric microphone mounted on a thumb element. These piezoelectric microphones capture valuable acoustic information about surface textures and material properties of manipulated objects, providing additional contextual data for training the neural network.

In some embodiments, the at least one piezoelectric microphone may be positioned on the side of the lower joint of the index finger element rather than on the back surface of the upper digit of the index finger element. In this configuration, vibrations still conduct mechanically through the structural elements of the wearable data collection device into the piezoelectric microphone, maintaining effective detection of contact sounds while providing advantages in terms of packaging efficiency and mechanical design. The piezoelectric microphone positioned at the base of the index finger element may be used in conjunction with a second piezoelectric microphone mounted on the thumb element to provide comprehensive acoustic data from multiple contact points during object manipulation. This alternative positioning of the piezoelectric microphone represents one of several possible sensor arrangements that may be implemented in the wearable data collection device while maintaining the fundamental functionality of capturing vibration data resulting from interaction with objects.

Data collection using the wearable device begins with the initiation of a recording session in response to a user input received via an activation mechanism on the data collection device. During the recording session, the various sensors capture data as the user manipulates objects while wearing the device. A processing circuit collects this sensor data and transmits it either to a mobile device mounted on the wearable data collection device or to an AR headset worn by the user, depending on the configuration. The recording session is terminated in response to a second user input received via the activation mechanism. The collected sensor data, along with position and orientation data from either the mobile device or the AR headset, is then used to train a neural network that controls the robotic counterpart device.

The mobile device, when used for position tracking, is secured to the wearable data collection device using a mobile device mount coupled to the hand element. In exemplary embodiments, the mobile device mount positions the mobile device in a backward-facing orientation such that the camera of the mobile device captures image data of the environment behind the wearable data collection device, which may include the wearer of the device. This configuration provides beneficial positioning data compared to forward-facing orientations by capturing more stable reference points in the environment for tracking. The mobile device tracks the position and orientation of the wearable data collection device in space during recording sessions using its inertial measurement unit, camera, or both. The sensor data from the wearable device is transmitted to the mobile device via a connection interface, which may comprise a wired connection (such as Universal Serial Bus (USB)) or a wireless connection.

The sensor data collected by the wearable data collection device may be utilized to train various types of machine learning models for controlling the robotic counterpart device. In one exemplary implementation, a neural network-based approach may be employed for imitation learning, wherein the network learns to map sensory inputs to appropriate control outputs based on human demonstrations. The neural network may comprise an encoder-decoder architecture, where the encoder processes the multi-modal sensory inputs to generate a compact latent representation, and the decoder translates this representation into control signals for the robotic counterpart device. This approach enables the model to identify patterns across different sensory modalities and generate appropriate robotic control responses.

In some implementations, the neural network may be structured as a transformer-based model that processes sequences of sensor data collected during recording sessions. The model inputs may include pressure data from the pressure sensors, angle data from the position sensors at each joint, visual data from the cameras, distance measurements from the time-of-flight sensors, and acoustic information from the piezoelectric microphones. Additionally, the position and orientation data of the wearable data collection device, as captured by either the mobile device or the AR headset, may be incorporated as input to the model. These inputs may be processed at regular intervals, such as ten times per second, to provide continuous control signals to the robotic counterpart device.

The training process may utilize imitation learning techniques, where the neural network learns to mimic the demonstrations provided by users wearing the data collection device. In one approach, the model may be trained using supervised learning methods, with the sensor data from the wearable device serving as input features and the corresponding movements or actions serving as target outputs. Alternatively, reinforcement learning approaches may be employed, where the model learns through trial and error, using the human demonstrations as reference for reward calculation. The specific training methodology may be selected based on factors such as the complexity of the manipulation tasks, the amount of available training data, and the computational resources available for model training.

It should be understood that the neural network architecture and training approach described above represent just one possible implementation, and various alternative machine learning techniques may be employed to achieve similar results. For example, rather than using a transformer-based neural network, the system might implement recurrent neural networks (RNNs), convolutional neural networks (CNNs), graph neural networks (GNNs), or hybrid architectures combining multiple network types. Similarly, the training methodology could incorporate other approaches such as contrastive learning, self-supervised learning, or meta-learning techniques to improve the model's ability to generalize across different manipulation tasks. The fundamental concept of collecting multi-modal sensory data with the wearable device and using this data to train models that control robotic counterparts remains applicable across these different implementation strategies.

It should also be understood that, while many examples and descriptions herein primarily discuss a single wearable data collection device worn on one hand of a user, the technology is equally applicable to configurations utilizing two wearable data collection devices simultaneously-one worn on each hand of the user. In such dual-device implementations, the two data collection devices are configured with opposing orientations to accommodate the natural symmetry of human hands, with each device independently capturing sensor data, position information, and visual data during recording sessions. The processing circuitry, communication interfaces, and data collection methodologies described herein function equivalently whether implemented in a single-device or dual-device configuration, with the training and control principles remaining fundamentally unchanged. This dual-device approach may be particularly beneficial for tasks requiring bimanual manipulation, enabling more comprehensive data collection for training robotic systems with corresponding bilateral capabilities.

Various technical effects may be appreciated from the implementations disclosed herein. Such technical effects include improved data fidelity through multi-modal sensing, enhanced spatial accuracy through optimized sensor positioning, and increased signal-to-noise ratio in sensor measurements. The strategic placement of time-of-flight sensors adjacent to cameras enables precise depth correlation with visual data, significantly reducing computational overhead that would otherwise be required for depth estimation algorithms. The backward-facing orientation of the mobile device camera provides superior position tracking accuracy by capturing more stable reference points in the environment, resulting in reduced drift and higher precision in spatial data. Similarly, integration with AR headsets leverages existing infrared tracking systems to achieve sub-millimeter positional accuracy without requiring additional computational resources.

The piezoelectric microphone placement on structural joints optimizes vibration conduction pathways while minimizing wire fatigue through reduced flex cycles, extending operational lifespan and maintaining signal integrity over extended use periods. Additionally, the constraint mechanisms that limit finger movements to match robotic capabilities eliminate the need for complex kinematic mapping algorithms, substantially reducing the computational complexity of the machine learning model training process. The compliant contact surfaces with custom-designed grip textures enhance force distribution across pressure sensors, improving measurement linearity and reducing hysteresis effects that typically compromise force data quality. These technical improvements collectively enable the creation of higher-fidelity training datasets, resulting in more precise and reliable robotic control models.

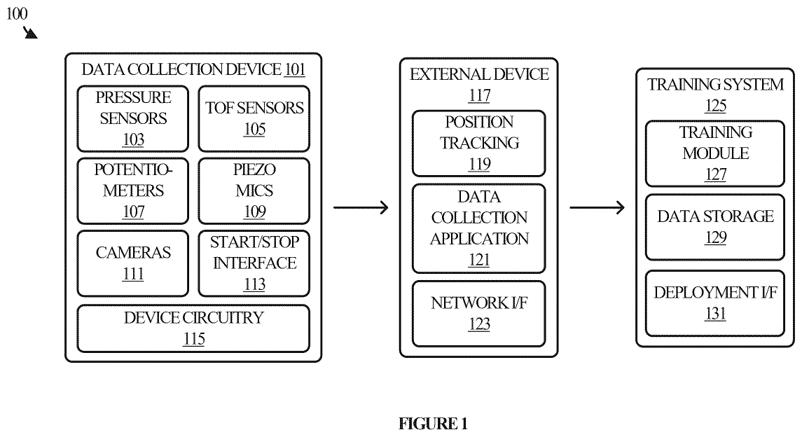

FIG. 1 illustrates data collection environment 100 in accordance with some embodiments of the present technology. Data collection environment 100 represents a system for gathering, processing, and utilizing sensor data for robot training purposes. Data collection environment 100 includes data collection device 101, external device 117, and training system 125. The elements depicted in FIG. 1 are presented solely for purposes of example, and data collection environment 100 may include additional, fewer, or alternative elements than those illustrated in the example of FIG. 1.

Data collection device 101 represents a wearable device configured to be worn on a user's hand to capture various types of data during manipulation tasks. Data collection device 101 includes pressure sensors 103, time-of-flight (ToF) sensors 105, potentiometers 107, piezoelectric microphones 109, cameras 111, start/stop interface 113, and device circuitry 115. While shown with specific sensor types in this example, data collection device 101 may incorporate additional sensing modalities or different configurations of the illustrated sensors depending on specific implementation requirements and the types of manipulation tasks being recorded.

Pressure sensors 103 are mounted on the data collection device 101 to measure forces applied during object manipulation. In some embodiments, pressure sensors 103 may include force sensitive resistors (FSRs) positioned on contact surfaces of each finger element of the data collection device. These sensors may be integrated directly beneath compliant gripping surfaces made of rubber or similar deformable materials. Pressure sensors 103 provide tactile feedback data that enables the trained robotic system to apply appropriate forces when manipulating objects of different fragilities and weights. Multiple pressure sensors may be distributed across different contact points of the device to capture comprehensive force distribution data during complex manipulation tasks.

Time-of-flight sensors 105 are mounted on data collection device 101 to provide precise distance measurements to objects in the environment. Each time-of-flight sensor may include a light emitter that projects light (typically infrared) and a grid of receivers (such as an eight-by-eight array) that detect reflections of this light. The sensors measure the time between emission and detection to calculate distances to objects with high (e.g., millimeter) precision. In some implementations, time-of-flight sensors 105 may be positioned proximate to cameras 111 to enable correlation between visual and depth data. Multiple time-of-flight sensors may be mounted at different locations on data collection device 101 to provide comprehensive spatial awareness from different perspectives, enabling more robust object detection and distance measurement for complex manipulation tasks.

Potentiometers 107 are positioned at the joints of data collection device 101 to measure angle data as the finger elements move relative to the hand element. These sensors capture the kinematic configuration of the device during object manipulation, tracking precisely how each joint rotates during different grasping and manipulation actions. Potentiometers 107 may be implemented as rotary sensors that convert angular position into electrical signals, providing continuous monitoring of joint positions throughout recording sessions. The angular data captured by potentiometers 107 is useful for training the neural network to understand the relationship between hand configuration and successful object manipulation strategies.

Piezoelectric microphones 109 are mounted on data collection device 101 to detect vibrations caused by contact between the device and objects. These microphones convert mechanical vibrations into electrical signals representing contact sound data, which provides valuable information about surface textures, material properties, and contact events. In some implementations, piezoelectric microphones 109 may be positioned on the back surfaces of finger elements or at the base of finger elements near joint locations. Multiple piezoelectric microphones may be distributed across different finger elements, such as the index finger and thumb, to capture acoustic information from various contact points during manipulation tasks.

Cameras 111 are mounted on data collection device 101 to capture visual data during recording sessions. These cameras may include small form-factor image sensors with wide-angle lenses to maximize the field of view from the hand's perspective. In some embodiments, multiple cameras may be positioned at different locations on the device to provide comprehensive visual coverage of the manipulation workspace. The visual data captured by cameras 111 enables the neural network to correlate visual cues with other sensor inputs and develop visually-guided manipulation strategies. These cameras may operate at various resolutions and frame rates depending on the specific requirements of the manipulation tasks being recorded.

Start/stop interface 113 provides a mechanism for users to control recording sessions on data collection device 101. This interface may be implemented as a physical button, touch sensor, pressure-sensitive region, or the like. In some examples, start/stop interface 113 is positioned within the thumb element of the device, allowing users to initiate and terminate recording sessions with simple thumb movements. In some implementations, start/stop interface 113 may support additional control functions beyond basic session control, such as marking specific events of interest during recording or switching between different recording modes. The interface is designed to be easily accessible while wearing the data collection device.

Device circuitry 115 represents the computational and communication components within data collection device 101 that process and transmit the sensor data. Device circuitry 115 may include microcontrollers, analog-to-digital converters, multiplexers, buffer memory, and communication interfaces for collecting and transmitting multi-modal sensor data. In some embodiments, device circuitry 115 may perform preliminary processing on the raw sensor data, such as filtering, normalization, or compression, to optimize data quality and transmission efficiency.

External device 117 represents a computing device that works in conjunction with data collection device 101 to track position, process sensor data, and facilitate data transmission to training system 125. External device 117 includes position tracking module 119, data collection application 121, and network interface 123. External device 117 may be implemented as a mobile device (e.g., smartphone or tablet) mounted on the data collection device, or as an augmented reality (AR) headset worn by the user with an associated controller secured to the data collection device. Other implementations of external device 117 may include dedicated data collection hardware specifically designed for this application.

Position tracking module 119 is responsible for determining the spatial position and orientation of data collection device 101 during recording sessions. In implementations using a mobile device, position tracking module 119 may utilize the device's inertial measurement unit (IMU), camera, and/or SLAM (Simultaneous Localization and Mapping) algorithms to track movement through space. In implementations using an AR headset, position tracking module 119 may leverage the headset's built-in tracking systems, which may use infrared cameras to track the position of a controller secured to data collection device 101. The position and orientation data captured by position tracking module 119 provides spatial context for the sensor data collected by data collection device 101.

Data collection application 121 runs on external device 117 and manages the overall data collection process. This application provides user interfaces for configuring recording sessions, visualizing sensor data in real-time, and managing the transfer of collected data to training system 125. Data collection application 121 may include functionality for data validation, preliminary quality assessment, and metadata annotation to enhance the usefulness of the collected data for training purposes. In some implementations, data collection application 121 may also provide guidance to users on performing specific manipulation tasks to ensure comprehensive coverage of relevant movement patterns in the training data.

Network interface 123 enables communication between external device 117 and training system 125. This interface may support various connectivity options, including Wi-Fi, cellular data, Bluetooth, or wired connections, depending on the specific implementation and operational environment. Network interface 123 facilitates the transmission of collected sensor data, position information, and associated metadata to training system 125 for storage and processing. In some deployments, network interface 123 may support both real-time data streaming for immediate feedback and batch uploads for large datasets collected over extended recording sessions.

Training system 125 represents the computational infrastructure responsible for processing the collected data and developing neural network models that control robotic counterpart devices. Training system 125 includes training module 127, data storage 129, and deployment interface 131. Training system 125 may be implemented as a cloud-based service, an on-premises computing cluster, or a hybrid architecture depending on computational requirements, data security considerations, and deployment constraints. The components of training system 125 work together to transform the raw sensor data into effective control models for robotic systems.

Training module 127 implements the machine learning algorithms and workflows needed to develop neural network models from the collected data. This module may include various neural network architectures, training methodologies, and optimization techniques suitable for imitation learning applications. Training module 127 processes the multi-modal sensor data to identify patterns and relationships between sensory inputs and effective manipulation strategies. The module may support different learning approaches, including supervised learning, reinforcement learning, or hybrid methods, depending on the complexity of the manipulation tasks and the characteristics of the available training data.

Data storage 129 provides repository capabilities for the sensor data, position information, and trained models within training system 125. This component may include databases, file systems, or specialized storage solutions optimized for handling large volumes of multi-modal time-series data. Data storage 129 not only maintains the raw training data but also stores intermediate processing results, model checkpoints, and performance metrics to support iterative model development and improvement. The storage system may implement data versioning, access controls, and backup mechanisms to ensure data integrity and availability throughout the model development lifecycle.

Deployment interface 131 facilitates the transfer of trained neural network models from training system 125 to robotic counterpart devices for real-world operation. This interface may support various deployment scenarios, including cloud-to-edge model distribution, on-premises model loading, and/or direct integration with robotic control systems. Deployment interface 131 ensures that the trained models are properly optimized, packaged, and configured for the specific computational resources and operational constraints of the target robotic systems. In some implementations, this interface may also support model monitoring, performance feedback, and iterative improvement workflows to enhance model effectiveness over time.

The configuration shown in FIG. 1 and described above represents just one example implementation of a data collection environment for training robotic systems. The actual components, their arrangement, and specific implementations may vary significantly while remaining within the scope of the present disclosure. For instance, data collection device 101 may include additional sensor types beyond those illustrated, such as humidity sensors, temperature sensors, or additional cameras. Multiple data collection devices may be used simultaneously, such as one device on each hand of a user. External device 117 may be implemented as various types of computing devices, including but not limited to smartphones, tablets, AR headsets, virtual reality (VR) controllers, dedicated computing hardware, or combinations thereof. Similarly, the specific architecture, distribution of processing, communication protocols, and storage mechanisms may be varied based on deployment requirements, computational resources, and application-specific constraints. These variations and others not explicitly described are contemplated as part of the present technology.

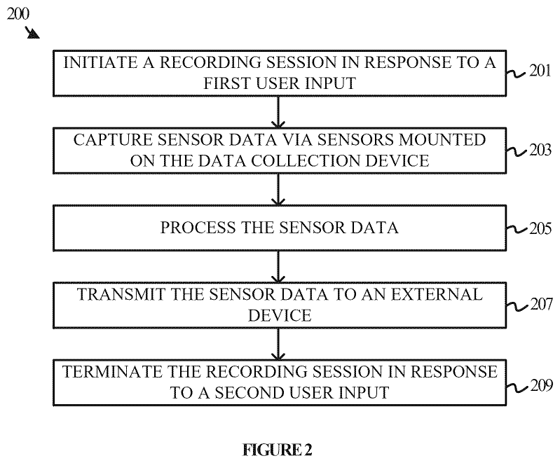

FIG. 2 illustrates process 200. Process 200 is an exemplary operation of a wearable data collection device for capturing training data in the context of data collection environment 100. The operations may vary in other examples. The operations of process 200, in some examples, are performed by data collection device 101 in the example of FIG. 1. Process 200 may be implemented in program instructions in the context of the software and/or firmware elements of device circuitry 115. The program instructions, when executed by one or more processing devices of data collection device 101, direct the data collection device to operate as follows, referring to the steps of FIG. 2.

The operations of process 200 include initiating a recording session in response to a first user input (step 201). In the example of FIG. 1, this user input may be received via start/stop interface 113 of data collection device 101. The user input may be provided as a button press, touch gesture, or other interaction with the activation mechanism. In some implementations, start/stop interface 113 is positioned within the thumb element of data collection device 101, allowing for convenient access during manipulation tasks. Upon receiving this input, device circuitry 115 activates the various sensors on data collection device 101 and begins collecting data for the recording session. In some implementations, device circuitry 115 may also send signals to external device 117 to synchronize the start of position tracking or to initialize data collection application 121.

Prior to initiating the recording session, the user typically inserts their hand into the hand element of data collection device 101, with their fingers positioned within the plurality of finger elements. These finger elements include three finger elements—a thumb element, an index finger element, and a pinky finger element—in some examples, but may include two, four, or five finger elements in other examples. In some configurations, the thumb element is fixed relative to the hand element, while one or all of the other finger elements (e.g., the index finger element and pinky finger element) are movable relative to the hand element. This arrangement constrains the user's hand movements to match the capabilities of the robotic counterpart device, ensuring that the recorded data can be effectively applied to control the robotic system. The plurality of joints connecting the finger elements to the hand element enable movement within this constrained range of motion, with potentiometers 107 or similar sensors at each moveable joint to track angular positions.

The operations of process 200 further include capturing sensor data via sensors mounted on the data collection device (step 203). In the example of FIG. 1, data collection device 101 captures data from pressure sensors 103, time-of-flight sensors 105, potentiometers 107, piezoelectric microphones 109, and cameras 111. Pressure sensors 103 may be positioned on each of the plurality of finger elements, such as beneath contact surfaces that interface with objects. These contact surfaces may comprise rubber materials configured to deform when contacting an object, improving grip while allowing the sensors to accurately measure applied forces. Potentiometers 107 or similar position sensors at the joints capture angle data as the finger elements move. Cameras 111 mounted on the device provide visual data from the perspective of the hand, while time-of-flight sensors 105 offer precise distance measurements to objects. Piezoelectric microphones 109 detect vibrations caused by contact between the device and objects, providing valuable acoustic information about surface textures and material properties.

During this step, the user performs manipulation tasks while wearing at least data collection device 101, such as grasping, lifting, rotating, or otherwise interacting with various objects. As the user manipulates objects, the objects contact the plurality of contact surfaces positioned on the finger elements of the device. The constrained movement of the finger elements ensures that these manipulation tasks are performed in ways that can be replicated by the robotic counterpart device. Simultaneously, the various sensors capture comprehensive data about these interactions, including forces applied, joint configurations, visual perspectives, distance measurements, and acoustic properties resulting from contact with different materials.

While capturing sensor data, the position and orientation of data collection device 101 in space may also be tracked during the recording session. This tracking, in some implementations, is performed by external device 117, which could be a mobile device mounted on data collection device 101, an AR headset worn by the user with a controller secured to data collection device 101, or the like. The position tracking enables spatial context to be associated with the sensor data, providing information about the trajectory and movement patterns during manipulation tasks. This positional data is particularly useful for training neural networks that will control the robotic counterpart device, as it enables the model to understand not just finger movements and forces but also the overall position of the hand in relation to objects and the environment.

The operations of process 200 further include processing the sensor data (step 205). In the example of FIG. 1, device circuitry 115 may perform various processing operations on the raw sensor data before transmission. These operations may include filtering to remove noise, normalization to standardize data ranges, compression to reduce bandwidth requirements, and/or formatting to organize the data for efficient transmission. The specific processing applied may vary based on the sensor type, with different algorithms optimized for pressure data, time-of-flight data, potentiometer readings, piezoelectric signals, and camera outputs. For example, piezoelectric microphone data may be transformed into spectrograms through Fourier transforms for more effective analysis, while time-of-flight data from multiple sensors may be combined to create more comprehensive depth maps. In some implementations, device circuitry 115 may also aggregate data from multiple sensors or perform time synchronization to ensure temporal alignment across different data streams.

The operations of process 200 further include transmitting the sensor data to an external device (step 207). In the example of FIG. 1, device circuitry 115 transmits the processed sensor data to external device 117. This transmission may occur via wired connections (e.g., USB) or wireless protocols depending on the specific implementation. The sensor data may be transmitted continuously throughout the recording session, in periodic batches, or using a combination of real-time streaming for critical data and batch transfers for high-volume data (such as camera imagery), as just a few examples. External device 117 receives this data through its corresponding interfaces and may further process, display, or store the information using data collection application 121 before eventually transferring it to training system 125 via network interface 123.

The transmitted sensor data, along with position and orientation data, serves as the foundation for training a neural network that controls the robotic counterpart device. This neural network is configured to map the sensor inputs to appropriate control outputs that enable the robotic device to perform similar manipulation tasks. The robotic counterpart device in this scenario has a joint and sensor configuration that matches data collection device 101, allowing for direct application of the learned manipulation strategies. By collecting data across multiple recording sessions involving different tasks, objects, and manipulation strategies, the neural network can develop a comprehensive understanding of effective manipulation techniques that can be applied to various scenarios.

The operations of process 200 further include terminating the recording session in response to a second user input (step 209). In the example of FIG. 1, this second user input may be received via start/stop interface 113, similar to the first user input but with a different contextual meaning due to the active recording state. The start/stop interface includes a different actuator for ending the recording, in some examples, but uses the same actuator as for starting the recording in other examples. Upon receiving this input, device circuitry 115 stops the sensor data collection process, completes any final data processing operations, and ensures all captured data has been successfully transmitted to external device 117. The recording session may be terminated when a specific task has been completed, when sufficient data has been collected for a particular manipulation strategy, or when the user needs to adjust the device or rest. In some implementations, device circuitry 115 may also perform cleanup operations such as releasing system resources, resetting sensor configurations, or entering a low-power state to conserve energy between recording sessions.

The configuration shown in FIGS. 1 and 2 and described above represents just one example implementation of a data collection environment and process for training robotic systems. The actual components, their arrangement, specific implementations, and process steps may vary significantly while remaining within the scope of the present disclosure. For instance, data collection device 101 may include additional sensor types beyond those illustrated, such as humidity sensors, temperature sensors, additional cameras, and the like. Multiple data collection devices may be used simultaneously, such as one device on each hand of a user. External device 117 may be implemented as various types of computing devices, including but not limited to smartphones, tablets, AR headsets, VR controllers, dedicated computing hardware, or combinations thereof. Similarly, the specific architecture, distribution of processing, communication protocols, and storage mechanisms may be varied based on deployment requirements, computational resources, and application-specific constraints. The process steps illustrated in FIG. 2 may be performed in different orders, combined, subdivided, or supplemented with additional operations depending on specific implementation requirements. These variations and others not explicitly described are contemplated as part of the present technology.

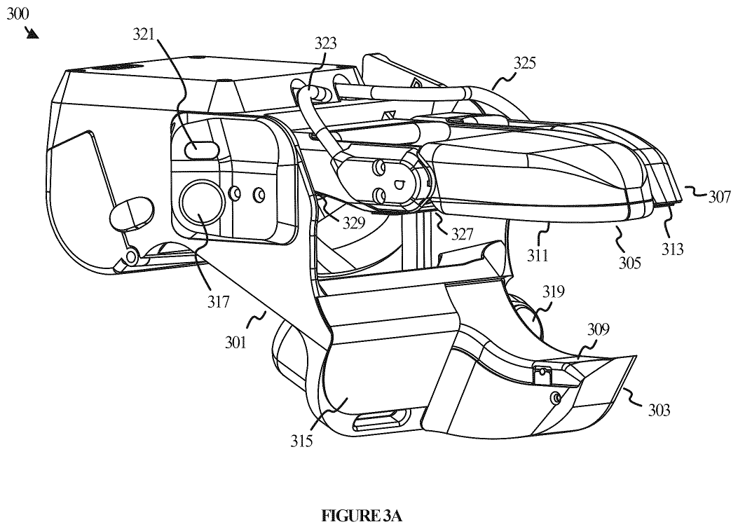

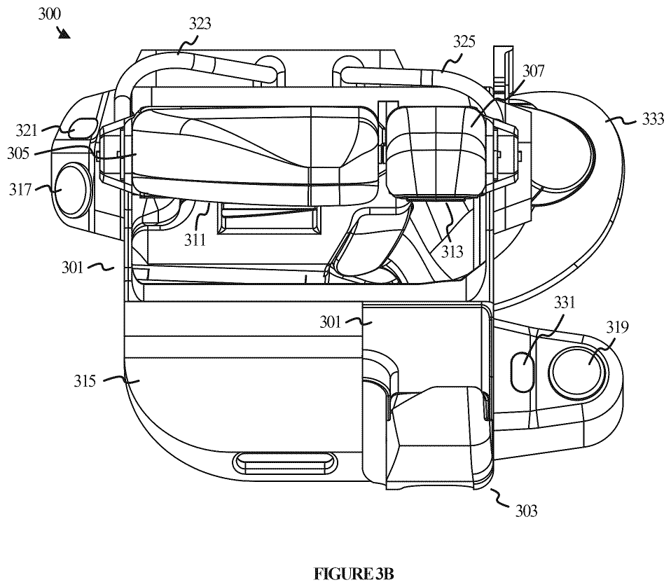

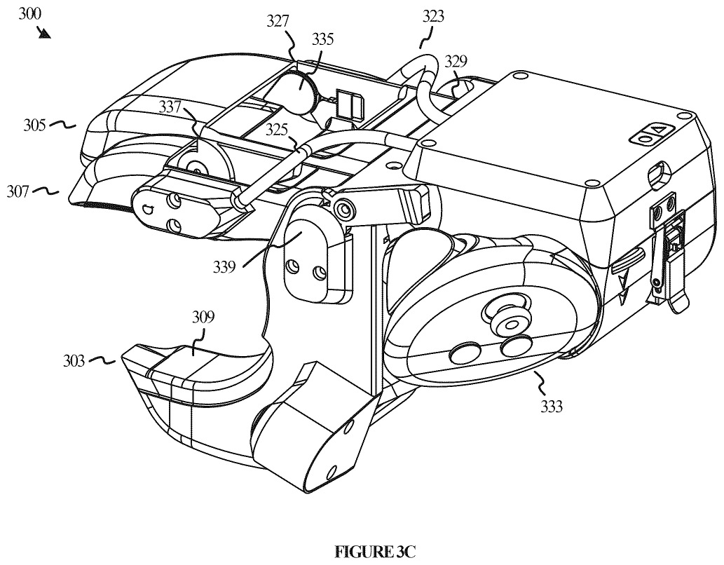

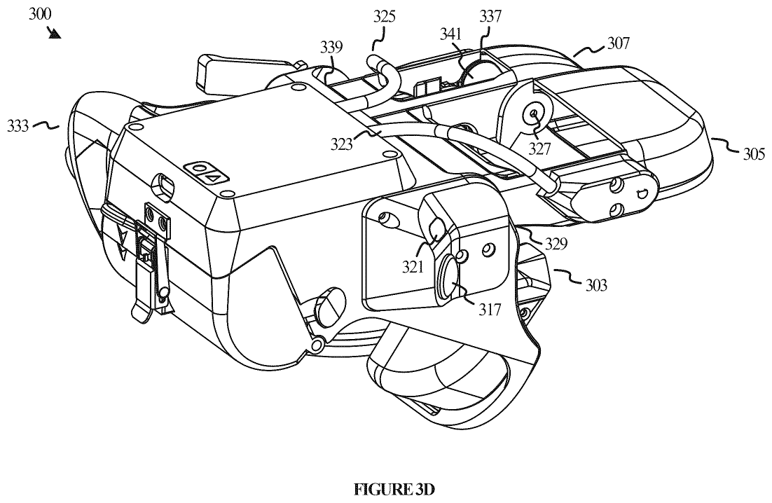

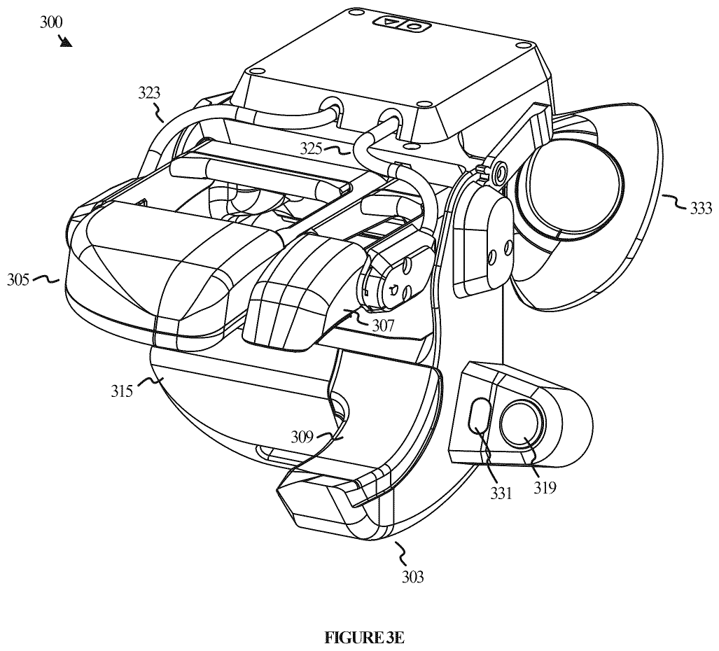

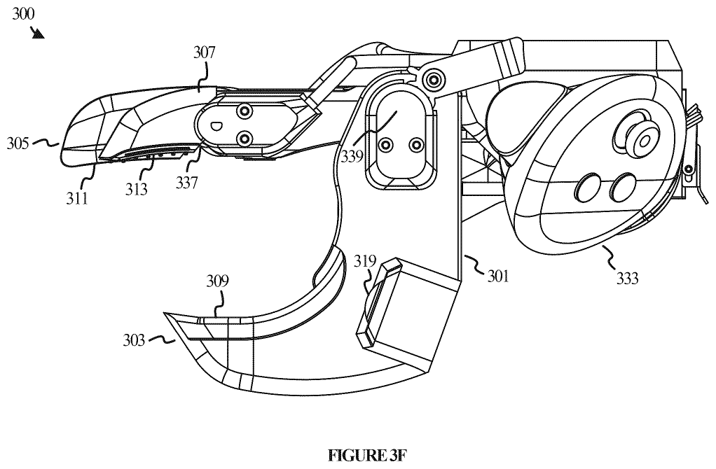

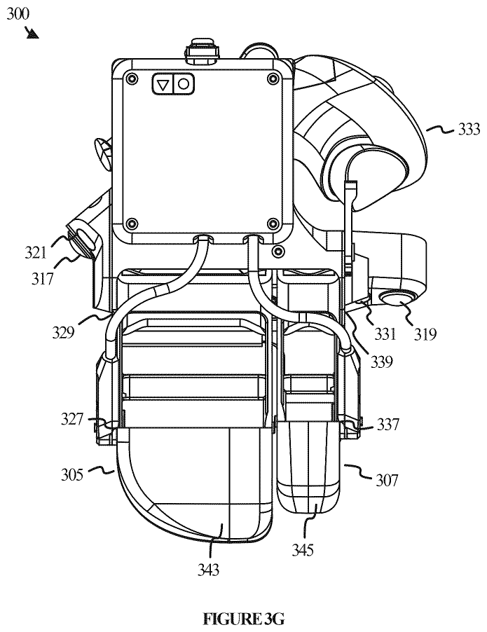

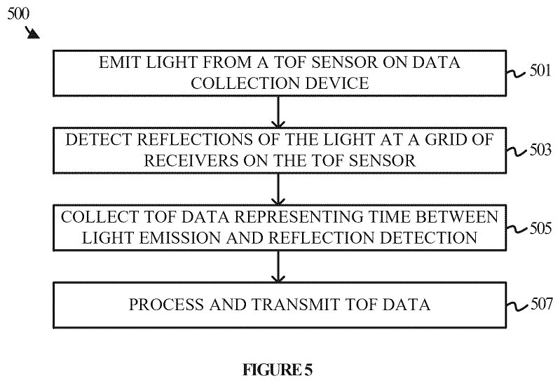

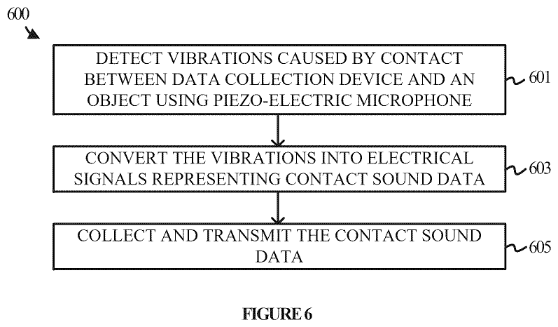

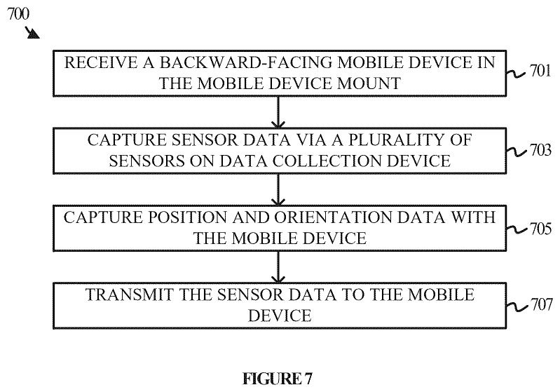

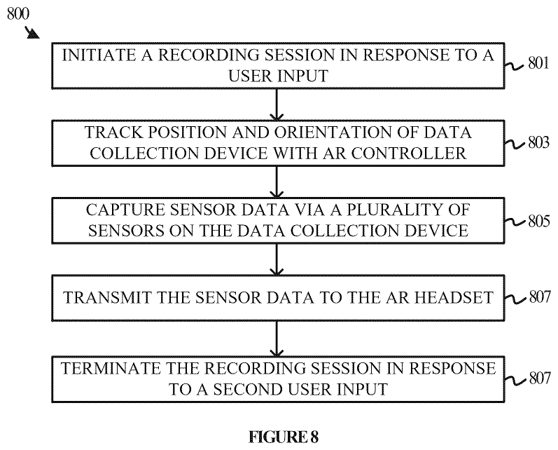

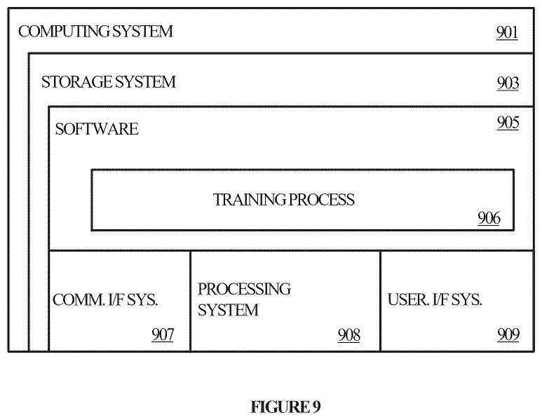

FIGS. 3A-31 illustrate wearable data collection device 300 in accordance with some embodiments of the present technology. Wearable data collection device 300 represents an implementation of data collection device 101 from FIG. 1. The elements depicted in FIGS. 3A-31 are presented solely for purposes of example, and wearable data collection device 300 may include additional, fewer, or alternative elements than those illustrated in the Figures.

FIG. 3A shows a first perspective view of wearable data collection device 300.

Wearable data collection device 300 includes hand element 301 configured to receive a hand of a user, thumb element 303, pinky finger element 305, and index finger element 307. Hand element 301 forms a base structure from which the plurality of finger elements extend. In the illustrated embodiment, wearable data collection device 300 includes three finger elements (thumb element 303, pinky finger element 305, and index finger element 307), though implementations with different numbers of finger elements are contemplated within the scope of this disclosure. Thumb element 303 is fixed relative to hand element 301 in the illustrated embodiment, while pinky finger element 305 and index finger element 307 are movably coupled to hand element 301 via their respective joints.

Each finger element includes at least one contact surface for interacting with objects during manipulation tasks. Thumb element 303 includes contact surface 309, which provides a gripping surface for manipulating objects. Similarly, pinky finger element 305 includes contact surface 311, and index finger element 307 includes contact surface 313. Hand element 301 includes contact surface 315 on its palm region, which enables grasping of thin objects with high force by providing a large 2D surface that can work in conjunction with the finger elements. In some embodiments, these contact surfaces comprise injection-molded soft thermoplastic elastomer (TPE) rubber with a custom grip texture, providing compliance and durability. The compliant nature of these rubber surfaces allows them to deform similar to human fingertips when contacting objects, improving grip characteristics while maintaining durability over extended use periods.

Wearable data collection device 300 further includes camera 317 and camera 319, which are mounted at different locations on the device to provide visual data from multiple perspectives. In the illustrated embodiment, cameras 317 and 319 are positioned such that if one camera is blocked by an object or by the finger elements themselves during manipulation, the other camera can still capture visual data. The strategic positioning of multiple cameras enhances the system's ability to maintain visual awareness throughout different manipulation tasks and hand positions.

Adjacent to camera 317 is time-of-flight (ToF) sensor 321, which provides precise distance measurements to objects in the environment. Similarly, time-of-flight sensor 331 is positioned proximate to camera 319, as shown in FIG. 3B. This configuration, with each camera having a corresponding time-of-flight sensor, enables easy correlation between visual and depth data, significantly enhancing the spatial awareness capabilities of the device. The time-of-flight sensors in this implementation have an expanded field of view compared to previous designs, allowing them to capture more comprehensive depth information from their respective vantage points.

FIG. 3A also shows controller 333 secured to wearable data collection device 300. Controller 333 is associated with an AR headset (not shown) and is mechanically mounted to hand element 301 such that controller 333 moves in coordination with wearable data collection device 300. This configuration enables the AR headset to track the position and orientation of controller 333, and by extension, wearable data collection device 300, providing precise spatial tracking for the data collection system. Unlike previous embodiments that utilized a mobile device for position tracking, this implementation leverages the AR headset's internal tracking mechanisms to monitor the position of controller 333 through infrared beacons or similar tracking features integrated into the controller.

Wearable data collection device 300 includes external wire 323 and external wire 325, which are routed with strain relief to minimize wire fatigue during repeated movements. These external wires connect various sensors on the device to the processing circuitry and provide communication pathways for transmitting sensor data to an external device, such as the AR headset. The routing of these wires is designed to reduce mechanical stress points and extend operational lifespan by implementing minimum bend radii of greater than 10 millimeters at flex points.

FIG. 3B shows a second perspective view of wearable data collection device 300, illustrating additional features of the device. This view more clearly shows time-of-flight sensor 331 positioned adjacent to camera 319, maintaining the pattern of pairing depth sensors with visual sensors throughout the device. FIG. 3B also provides a clearer view of contact surface 315 on the palm region of hand element 301, which works in conjunction with the finger elements to enable stable grasping of objects across a wide range of sizes and shapes.

FIG. 3C shows a third perspective view of wearable data collection device 300, highlighting the joint mechanisms that connect the finger elements to hand element 301. Pinky finger element 305 is connected to hand element 301 via proximal joint 327, which enables rotation of pinky finger element 305 relative to hand element 301. Additionally, pinky finger element 305 includes distal joint 329, which connects distal segment 343 to a proximal segment of pinky finger element 305, enabling articulation of the distal portion of the finger element. Similarly, index finger element 307 includes proximal joint 339, which attaches the finger element to hand element 301, and distal joint 337, which connects distal segment 345 to the remainder of index finger element 307.

These joints are designed to enable movement of the finger elements within a constrained range of motion that corresponds to the movement capabilities of a robotic counterpart device. By limiting the degrees of freedom and range of motion to match the robotic system's capabilities, wearable data collection device 300 ensures that all recorded manipulations can be effectively reproduced by the robotic counterpart device. In some implementations, each movable joint includes at least one position sensor, such as a potentiometer, to capture angle data as the finger elements move relative to hand element 301.

FIG. 3C also shows hinge 335 located at distal joint 329 of pinky finger element 305. Hinge 335 forms part of the mechanical structure that enables articulation of distal segment 343 relative to the remainder of pinky finger element 305. The hinge mechanism is designed to provide smooth, consistent movement while accommodating the integration of position sensors and internal wiring. The implementation shown represents an improvement over previous designs by enhancing structural integrity at the joint regions.

FIG. 3D shows a fourth perspective view of wearable data collection device 300, providing a clearer visualization of the finger element articulation mechanisms. This view shows hinge 341 located at distal joint 337 of index finger element 307, which enables articulation of distal segment 345. The illustrated joint configuration enables the finger elements to grasp objects with diameters ranging from approximately 4 millimeters to 110 millimeters.

FIG. 3E shows a fifth perspective view of wearable data collection device 300, emphasizing the spatial relationship between the various finger elements, cameras, and time-of-flight sensors. This view illustrates how the three finger elements work together to form an effective manipulation system, with thumb element 303 providing a fixed reference point while pinky finger element 305 and index finger element 307 offer adjustable grasping positions via their articulated joints. The strategic positioning of camera 317, camera 319, time-of-flight sensor 321, and time-of-flight sensor 331 ensures comprehensive coverage of the manipulation workspace from multiple perspectives.

FIG. 3F shows a sixth perspective view of wearable data collection device 300, highlighting the overall structure and arrangement of components. This view more clearly shows how controller 333 is integrated with hand element 301, enabling position tracking via an AR headset system. When a user inserts their hand into hand element 301, the user is not holding controller 333 directly; rather, controller 333 is mechanically mounted to wearable data collection device 300 such that it moves in coordination with the device. This approach simplifies the user experience while maintaining precise position tracking capabilities.

FIG. 3G shows a seventh perspective view of wearable data collection device 300, providing additional detail on the distal segments of the finger elements. Distal segment 343 of pinky finger element 305 and distal segment 345 of index finger element 307 are designed to bend and potentially become flush with contact surface 315 of the palm region, enabling stable grasping of thin objects with high force. This design element represents an improvement over other implementations by increasing the effective contact area available for manipulating thin objects.

FIG. 3H shows an eighth perspective view of wearable data collection device 300, emphasizing the articulation capabilities of the finger elements. This view illustrates how pinky finger element 305 and index finger element 307 can bend at their respective joints to form different grasping configurations. The design of pinky finger element 305 and index finger element 307 allows them to articulate independently of one another, even though they may rotate about parallel or coincident axes at their proximal joints. This independent movement capability enables complex manipulation strategies involving different finger configurations.

FIG. 3I shows a ninth perspective view of wearable data collection device 300, providing a side view that emphasizes the integration of controller 333 with hand element 301. This structural arrangement ensures that the position tracking system can accurately monitor the movements of wearable data collection device 300 throughout recording sessions.

While not explicitly labeled in the figures, wearable data collection device 300 incorporates various sensors beyond the visible cameras and time-of-flight sensors. These include pressure sensors positioned beneath the contact surfaces of each finger element to measure forces applied during object manipulation. In some implementations, these pressure sensors are force sensitive resistors (FSRs) directly mounted beneath the rubber contact surfaces. The simplified sensor integration enhances reliability while maintaining accurate force measurements compared to other designs.

Wearable data collection device 300 also includes piezoelectric microphones mounted at strategic locations to detect vibrations caused by contact between the device and objects. While not visible in the figures, one piezoelectric microphone may be positioned at the base of index finger element 307, on the lower joint of that finger, and another may be positioned near the tip of thumb element 303. This configuration enables the detection of contact sounds from multiple interaction points, providing acoustic information about surface textures and material properties. The internal positioning of these microphones represents an optimization for packaging efficiency and mechanical design while maintaining effective vibration detection capabilities.

Additionally integrated into wearable data collection device 300 is a processing circuit operatively coupled to the various sensors. This processing circuit collects sensor data from the pressure sensors, position sensors, cameras, time-of-flight sensors, and piezoelectric microphones during recording sessions. The processing circuit transmits this sensor data to an external device, such as the AR headset associated with controller 333, such as via a USB connection or similar interface.

Additionally, wearable data collection device 300 includes an activation mechanism, such as a custom-molded diaphragm button in thumb element 303, that enables a wearer to initiate and terminate recording sessions. This activation mechanism is designed with waterproof sealing features to prevent sweat ingress, enhancing reliability compared to previous implementations.

The wearable data collection device 300 may also include an inertial measurement unit (IMU), as well as humidity and temperature sensors, though these components are not specifically shown or labeled in the Figures. An IMU may provide orientation data that supplements the position tracking information from the AR headset system, while the humidity and temperature sensors enable detection of environmental conditions and potential water ingress that could affect sensor performance.

Furthermore, wearable data collection device 300 may incorporate a knitted compression sleeve with elastic straps that secure the user's hand in the device. This attachment approach simplifies the process of donning and removing the device, particularly when using two devices simultaneously (one on each hand).

In operation, a user wears wearable data collection device 300 by inserting their hand through hand element 301, which serves as an entry point to the device. The user's thumb is positioned within thumb element 303, while their index finger is inserted into index finger element 307. The remaining three fingers of the user's hand (middle, ring, and pinky fingers) are collectively positioned within pinky finger element 305. This arrangement provides a natural hand posture while ensuring that all user finger movements are properly constrained to match the capabilities of the robotic counterpart device. Once the hand is properly positioned, the user may secure the device using the knitted compression sleeve and/or elastic straps, which pull the hand firmly into the device and maintain consistent positioning throughout the recording session. To initiate a recording session, the user presses the activation mechanism located within thumb element 303, by applying pressure with their thumb. When the manipulation task is complete, the user presses the same activation mechanism again to terminate the recording session. In implementations using the AR headset, the user would also wear the headset prior to beginning the recording session, enabling spatial tracking of controller 333 and providing a complete view of the environment during the manipulation tasks.

The configuration shown in FIGS. 3A-31 and described above represents just one example implementation of a wearable data collection device for training robotic systems. The specific components, their arrangement, dimensions, materials, and other characteristics may vary significantly in other implementations while remaining within the scope of the present disclosure. For instance, different numbers of finger elements, alternative sensor types and placements, varied joint mechanisms, alternative position tracking technologies, or other modifications may be incorporated based on specific application requirements, ergonomic considerations, or technological advancements. These variations and others not explicitly described are contemplated as part of the present technology.

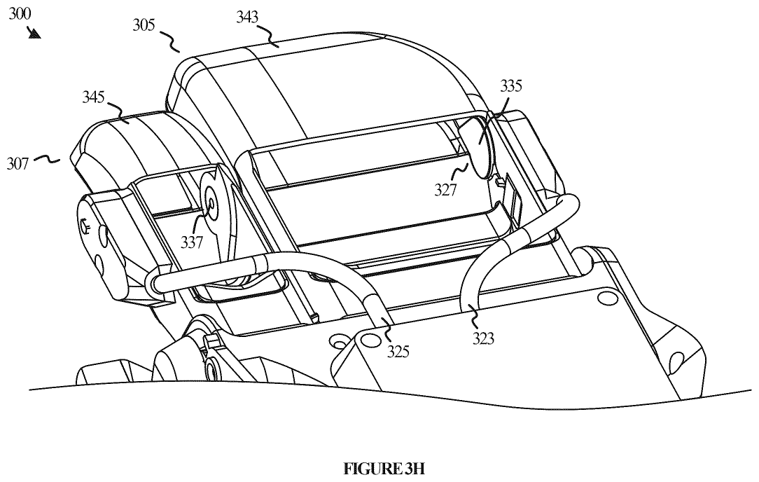

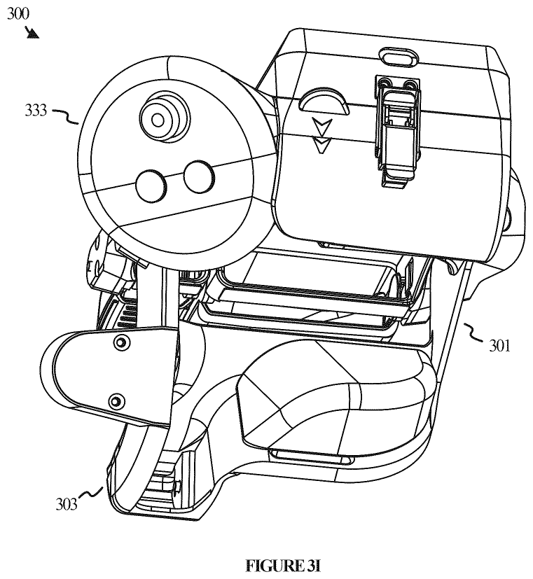

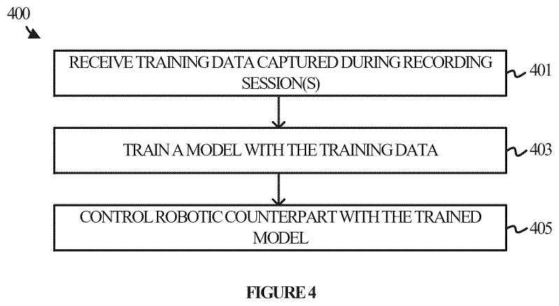

FIG. 4 illustrates process 400. Process 400 is an exemplary operation for training and deploying a robotic control model using sensor data gathered by a wearable data collection device. The operations may vary in other examples. The operations of process 400, in some examples, are performed by training system 125 in the example of FIG. 1, though they may alternatively be implemented on cloud computing infrastructure, high-performance computing clusters, or other computational systems with sufficient processing capabilities. Process 400 may be implemented in program instructions in the context of the software and/or firmware elements of training module 127. The program instructions, when executed by one or more processing devices of a suitable computing system, direct the computing system to operate as follows, referring to the steps of FIG. 4.

The operations of process 400 include receiving training data captured during one or more recording sessions (step 401). In the example of FIG. 1, training module 127 receives sensor data that has been collected by data collection device 101, processed by device circuitry 115, transmitted to external device 117, and then forwarded to training system 125 via network interface 123. This training data may include various types of sensor data captured during recording sessions, such as pressure data from pressure sensors positioned on each finger element, angle data from position sensors at the joints, visual data from cameras mounted on the data collection device, time-of-flight data from ToF sensors representing distance measurements to objects, and contact sound data from piezoelectric microphones. The training data may further include position and orientation data of the wearable data collection device in space, which may be captured by a mobile device mounted on the data collection device or by an AR headset tracking a controller secured to the data collection device.

In implementations utilizing a mobile device for position tracking, the training data may include spatial tracking information from a backward-facing orientation of the mobile device, wherein the camera of the mobile device is positioned to face away from the finger elements of the wearable data collection device. This backward-facing configuration provides superior position tracking accuracy by capturing more stable reference points in the surrounding environment. The training data may also include environmental image data from this backward-facing camera, which provides contextual information about the environment behind the wearable data collection device during recording sessions.

In implementations utilizing an AR headset for position tracking, the training data may include spatial tracking information derived from the AR headset's tracking of a controller secured to the wearable data collection device. This approach leverages the AR headset's built-in tracking systems, which may use infrared cameras to monitor the position of the controller with high precision. The training data may also include head position and orientation data from the AR headset, providing information about where the user was looking during manipulation tasks, as well as visual data captured by a camera mounted on the AR headset, offering a broader perspective of the environment during recording sessions.

The operations of process 400 further include training a model with the training data (step 403). In the example of FIG. 1, training module 127 processes the received data to train a neural network model that can control a robotic counterpart device. The neural network may be configured to map sensor inputs to appropriate control outputs based on the demonstrations provided in the training data. During this step, the training data is processed to identify patterns and relationships between sensory inputs and effective manipulation strategies. The neural network learns to recognize how different sensory inputs-such as pressure patterns, joint angles, visual cues, distance measurements, and acoustic signatures-correlate with successful object manipulation techniques.

The training process may involve various machine learning approaches, including supervised learning, reinforcement learning, or hybrid methods. In supervised learning approaches, the sensor data serves as input features and the corresponding movements or actions serve as target outputs. The neural network learns to predict appropriate control signals based on the sensory inputs by minimizing the difference between its predictions and the observed human demonstrations. In reinforcement learning approaches, the model learns through a reward-based system, where successful manipulation strategies are reinforced through positive feedback signals.

During the training process, the system may analyze multiple recording sessions involving different tasks, objects, and manipulation strategies. This diverse training dataset enables the neural network to identify generalizable patterns that can be applied across various scenarios. The training process may also involve data augmentation techniques to enhance the robustness of the model, such as introducing controlled variations in the sensor data to simulate different environmental conditions or object properties.

The training process may incorporate various neural network architectures depending on the specific requirements of the manipulation tasks. For time-of-flight sensor data, the training process may include specialized components that learn to interpret the grid of distance measurements to build accurate spatial representations of the manipulation environment. For piezoelectric microphone data, the training process may include transforming the contact sound data into spectrograms through Fourier transforms and then training the neural network to recognize patterns in these spectrograms that correspond to different surface textures and material properties. For visual data, the training process may employ convolutional neural networks or similar architectures that excel at extracting features from visual inputs.

The operations of process 400 further include controlling the robotic counterpart with the trained model (step 405). In the example of FIG. 1, the trained neural network model is deployed via deployment interface 131 to control a robotic counterpart device that has a joint and sensor configuration matching the wearable data collection device. The robotic counterpart device may be a robotic arm with a gripper attachment that mimics the structure and movement capabilities of the wearable data collection device, ensuring that the manipulation strategies learned from human demonstrations can be effectively reproduced by the robotic system.

During operational use, the robotic counterpart device receives real-time sensor data from its various sensors, which include sensors corresponding to those on the wearable data collection device-pressure sensors, position sensors, cameras, time-of-flight sensors, and piezoelectric microphones. This real-time sensor data is processed using the trained neural network model to determine appropriate control signals for the robotic device. The control signals are then transmitted to the robotic counterpart device to govern its movements and interactions with objects in its environment.

The control process may operate in a continuous feedback loop, where the neural network model constantly receives updated sensor information and adjusts the control signals accordingly. This enables the robotic counterpart device to adapt to changing environmental conditions and object properties during manipulation tasks. For example, the model might adjust the applied force based on real-time pressure readings, modify the approach angle based on time-of-flight sensor data, or alter the grip strategy based on contact sound information from the piezoelectric microphones.

In some implementations, the control process may include additional refinement mechanisms that improve performance over time. For example, the system may collect performance metrics during robotic operations and use this data to further refine the neural network model through techniques such as online learning or periodic retraining. The system may also analyze patterns across multiple operational sessions to identify consistent challenges or areas for improvement in the control model.

The robotic counterpart device may be deployed in various applications, including manufacturing, logistics, healthcare, service settings, and the like. The specific implementation details of the control system may vary based on the operational requirements of these different domains. For example, manufacturing applications might prioritize precision and repeatability, while service applications might emphasize adaptability and safety in human-robot interactions.

In some implementations, the control system may operate multiple robotic counterpart devices simultaneously, each corresponding to one wearable data collection device used during training. This enables coordinated bimanual manipulation tasks that require synchronized movements between two robotic effectors. The neural network model in these implementations would be trained with data from dual-device recording sessions, allowing it to learn effective coordination strategies for complex manipulation tasks requiring two hands.

The configuration shown in FIG. 4 and described above represents just one example implementation of a process for training and deploying a robotic control model. The actual training methodologies, neural network architectures, deployment strategies, and control mechanisms may vary significantly while remaining within the scope of the present disclosure. For instance, the training process might incorporate different machine learning techniques, such as transfer learning, meta-learning, or multi-task learning, to enhance the capabilities of the trained model. The control system might implement various refinement mechanisms, including reinforcement learning from operational feedback, to continuously improve performance. Different deployment architectures, including edge computing, cloud-based control, or hybrid approaches, might be used depending on latency requirements, computational constraints, and connectivity considerations. These variations and others not explicitly described are contemplated as part of the present technology.

FIG. 5 illustrates process 500. Process 500 is an exemplary operation of using time-of-flight sensors on a wearable data collection device to generate precise distance measurements for training a robotic system. The operations may vary in other examples. The operations of process 500, in some examples, are performed by data collection device 101 in the example of FIG. 1, specifically utilizing time-of-flight sensors 105 and/or wearable data collection device 300. Process 500 may be implemented in program instructions in the context of the software and/or firmware elements of device circuitry 115. The program instructions, when executed by processing circuitry of the data collection device, direct the device to operate as follows, referring to the steps of FIG. 5.

The operations of process 500 include emitting light from a time-of-flight (ToF) sensor on the data collection device (step 501). In the example of FIG. 1, time-of-flight sensors 105 of data collection device 101 each include a light emitter configured to project light, typically in the infrared spectrum, toward objects in the environment. The light emission may be pulsed at high frequencies to enable precise timing measurements. In some implementations, as shown in FIGS. 3A-31, multiple time-of-flight sensors (e.g., time-of-flight sensor 321 and time-of-flight sensor 331) are positioned at different locations on the wearable data collection device, with each sensor emitting light from its respective position. This multi-sensor configuration provides comprehensive spatial awareness from different vantage points, enhancing the device's ability to generate accurate depth information about the manipulation environment.

In certain embodiments, each time-of-flight sensor is surrounded by a bevel that controls the angular distribution of the emitted light. The bevel is designed with a specific non-square shape to expand the field of view of the sensor while preventing the emitted light from bouncing off the walls of the protective cover, which would create false readings. This specialized design enables the sensor to maintain accuracy while covering a larger sensing area, significantly improving the device's ability to detect objects in the manipulation workspace.

The operations of process 500 further include detecting reflections of the light at a grid of receivers on the ToF sensor (step 503). In the example of FIG. 1, the grid of receivers on time-of-flight sensors 105 detects the light that has been reflected back from objects in the environment. In some implementations, each time-of-flight sensor includes an eight-by-eight grid of receivers, creating an array of sixty-four individual detection points. Each receiver in this grid independently detects reflected light, enabling the sensor to create a detailed depth map of the environment. By using multiple time-of-flight sensors positioned at different locations on the device, as shown in FIGS. 3A-31 with time-of-flight sensor 321 proximate to camera 317 and time-of-flight sensor 331 proximate to camera 319, the system can detect objects from different angles simultaneously, reducing blind spots and enhancing overall spatial awareness.

The operations of process 500 further include collecting time-of-flight data representing time between light emission and reflection detection (step 505). In the example of FIG. 1, time-of-flight sensors 105 measure the time elapsed between the emission of light pulses and the detection of their reflections at each receiver in the grid. Given the known speed of light, these time measurements are converted into precise distance calculations for each point in the grid. With an eight-by-eight grid of receivers, each time-of-flight sensor generates sixty-four individual time measurements, creating a detailed spatial map of the environment from that sensor's vantage point. The combination of data from multiple time-of-flight sensors positioned at different locations on the device provides comprehensive three-dimensional information about the manipulation workspace and objects within it.

When objects are being manipulated by the wearable data collection device, the time-of-flight data provides information about the distance to these objects, their spatial configuration, and changes in their position over time. This depth information is particularly valuable in scenarios where visual data alone might be insufficient, such as in low-light conditions or when dealing with visually ambiguous objects. By capturing precise distance measurements, the time-of-flight sensors enable more accurate and reliable manipulation strategies to be learned and subsequently implemented by the robotic counterpart device.

The operations of process 500 further include processing and transmitting the ToF data (step 507). In the example of FIG. 1, device circuitry 115 processes the raw time-of-flight data collected from time-of-flight sensors 105 before transmission. This processing may include filtering to reduce noise, calibration to ensure accuracy, normalization to standardize data ranges, and/or formatting to organize the data for efficient transmission. The processed time-of-flight data is then transmitted to external device 117 along with other sensor data from the wearable data collection device. External device 117 may further process this data before forwarding it to training system 125 for use in training the neural network model.

The transmission of time-of-flight data may be synchronized with other sensor data, such as visual data from cameras positioned adjacent to the time-of-flight sensors. This synchronization enables the training system to correlate depth information with visual features, significantly enhancing the neural network's ability to understand the spatial relationships between the wearable data collection device and objects in the environment. The combination of visual and depth data provides a more complete representation of the manipulation environment than either data type alone could offer.

The time-of-flight data collected and transmitted through this process serves as input for training the neural network model that will control the robotic counterpart device. The neural network learns to interpret this depth information and use it to guide manipulation strategies, such as determining appropriate approach trajectories, maintaining optimal distances during manipulation tasks, and detecting potential collisions before they occur. When the trained model is deployed to the robotic counterpart device, which has a matching sensor configuration including time-of-flight sensors, the robot can leverage similar depth perception capabilities to execute manipulation tasks effectively.

The configuration shown in FIG. 5 and described above represents just one example implementation of a process for utilizing time-of-flight sensors on a wearable data collection device. The specific time-of-flight sensor technologies, their arrangement on the device, the processing methods applied to the collected data, and the ways in which this data is utilized in the training process may vary significantly while remaining within the scope of the present disclosure. For instance, the time-of-flight sensors might use different detection technologies, operate at different wavelengths, or employ alternative grid configurations. The processing of time-of-flight data might incorporate advanced algorithms for noise reduction, feature extraction, or sensor fusion. The integration of time-of-flight data with other sensor modalities might employ various synchronization techniques or weighting schemes in the neural network architecture. These variations and others not explicitly described are contemplated as part of the present technology.

FIG. 6 illustrates process 600. Process 600 is an exemplary operation of using piezoelectric microphones on a wearable data collection device to capture contact sound data for training a robotic system. The operations may vary in other examples. The operations of process 600, in some examples, are performed by data collection device 101 in the example of FIG. 1, specifically utilizing piezoelectric microphones 109, and/or wearable data collection device 300. Process 600 may be implemented in program instructions in the context of the software and/or firmware elements of device circuitry 115. The program instructions, when executed by processing circuitry of the data collection device, direct the device to operate as follows, referring to the steps of FIG. 6.

The operations of process 600 include detecting vibrations caused by contact between the data collection device and an object using a piezoelectric microphone (step 601). In the example of FIG. 1, piezoelectric microphones 109 on data collection device 101 detect mechanical vibrations that occur when the device contacts and interacts with objects. These vibrations travel through the structure of the wearable data collection device to the piezoelectric microphones, which are specifically designed to detect these minute mechanical oscillations. In some implementations, multiple piezoelectric microphones are mounted at different locations on the wearable data collection device. In one configuration, a first piezoelectric microphone is mounted on the back surface of the upper digit of the index finger element and a second piezoelectric microphone is mounted on the thumb element. In an alternative configuration, the first piezoelectric microphone may be positioned on the side of the lower joint of the index finger element rather than on the back surface of the upper digit of the index finger element, while the second piezoelectric microphone is mounted on the thumb element (e.g., near the tip of the thumb element).

Both piezoelectric microphone mounting configurations provide significant advantages, though through different mechanisms. In the back-surface mounting configuration, positioning the microphones on the back surfaces of finger elements-opposite from the contact surfaces that directly interact with objects-prevents overly spiked inputs when objects are grasped. In the side-joint mounting configuration, placing the microphone on the side of the lower joint of the index finger improves packaging efficiency and mechanical design while maintaining effective vibration detection. Despite being positioned away from the direct contact points in both configurations, the vibrations effectively conduct mechanically through the structural elements of the wearable data collection device into the piezoelectric microphones. The side-joint positioning represents an optimization that maintains similar signal quality while providing advantages in terms of wire routing, with vibrations still conducting effectively through the mechanical structures into the piezoelectric microphone. This alternative positioning exemplifies the various sensor arrangements that may be implemented while maintaining the fundamental functionality of capturing vibration data resulting from interaction with objects.

When the wearable data collection device interacts with different materials and surfaces, characteristic vibrations are generated that correspond to the physical properties of those materials. For example, interactions with rough surfaces produce different vibration patterns than interactions with smooth surfaces. Similarly, hard materials generate distinct vibration signatures compared to soft materials. These vibration patterns provide valuable tactile information that humans naturally use when manipulating objects but that is challenging to capture with traditional sensors like cameras or pressure sensors. The piezoelectric microphones enable the wearable data collection device to detect these subtle acoustic signatures, significantly enhancing the richness of the collected training data.

The operations of process 600 further include converting the vibrations into electrical signals representing contact sound data (step 603). In the example of FIG. 1, piezoelectric microphones 109 utilize piezoelectric materials that generate electrical charges in response to mechanical stress. When vibrations reach these microphones, the piezoelectric materials convert the mechanical energy of the vibrations into corresponding electrical signals that represent the acoustic patterns of the contact events. These electrical signals capture various characteristics of the contact sounds, including frequency content, amplitude, duration, and temporal patterns, all of which contain information about the physical interaction between the wearable data collection device and objects in the environment.

The electrical signals generated by the piezoelectric microphones provide a unique data modality that complements other sensor inputs such as pressure readings, position data, and visual information. While pressure sensors indicate the force applied during manipulation and cameras provide visual context, the piezoelectric microphones capture the acoustic characteristics of surface interactions. This multi-modal approach enables a more comprehensive understanding of object properties and manipulation dynamics, allowing for more sophisticated and adaptive robotic control strategies.

The operations of process 600 further include collecting and transmitting the contact sound data (step 605). In the example of FIG. 1, device circuitry 115 collects the electrical signals from piezoelectric microphones 109 and performs initial processing on this contact sound data. This processing may include amplification to enhance signal strength, filtering to remove noise, and analog-to-digital conversion to prepare the data for digital transmission and analysis. In some implementations, the processing may also include transforming the contact sound data into spectrograms through Fourier transforms, which convert the time-domain signals into frequency-domain representations that more effectively capture the spectral characteristics of the contact sounds.

After processing, the contact sound data is transmitted to external device 117 along with other sensor data from the wearable data collection device. This transmission may occur via wired connections (e.g., USB) or wireless protocols depending on the specific implementation. External device 117 may further process this data before forwarding it to training system 125 for use in training the neural network model. The transmission of contact sound data is synchronized with other sensor data to ensure temporal alignment, enabling the training system to correlate acoustic events with corresponding visual, pressure, and position information.

The contact sound data collected and transmitted through this process serves as a valuable input for training the neural network model that will control the robotic counterpart device. The neural network learns to associate specific acoustic signatures with particular material properties and surface characteristics, enabling more effective object identification and manipulation strategies. For example, the model may learn to adjust grasping force based on acoustic feedback indicating surface texture or material compliance, or it may learn to identify successful contact events based on characteristic sound patterns.

When the trained model is deployed to the robotic counterpart device, which has a matching sensor configuration including piezoelectric microphones, the robot can utilize similar acoustic sensing capabilities to execute manipulation tasks effectively. The real-time contact sound data provided by the piezoelectric microphones on the robotic device enables continuous adaptation to changing object properties and environmental conditions during manipulation tasks, significantly enhancing the system's robustness and versatility.

The configuration shown in FIG. 6 and described above represents just one example implementation of a process for utilizing piezoelectric microphones on a wearable data collection device. The specific microphone technologies, their placement on the device, the processing methods applied to the collected data, and the ways in which this data is utilized in the training process may vary significantly while remaining within the scope of the present disclosure. For instance, the microphones might use different piezoelectric materials, employ alternative mounting techniques, or be positioned at different locations on the device while maintaining the same fundamental functionality. The processing of contact sound data might incorporate different signal processing algorithms, feature extraction methods, or classification techniques. These variations and others not explicitly described are contemplated as part of the present technology.

FIG. 7 illustrates process 700. Process 700 is an exemplary operation of using a mobile device with a wearable data collection device to track position and orientation during recording sessions. The operations may vary in other examples. The operations of process 700, in some examples, are performed by data collection device 101 in the example of FIG. 1, in conjunction with external device 117 implemented as a mobile device, and/or by wearable data collection device 300. Process 700 may be implemented in program instructions in the context of the software and/or firmware elements of device circuitry 115 and data collection application 121. The program instructions, when executed by processing circuitry of the relevant devices, direct the devices to operate as follows, referring to the steps of FIG. 7.

The operations of process 700 include receiving a backward-facing mobile device in the mobile device mount (step 701). In the example of FIG. 1, a mobile device serving as external device 117 is secured to data collection device 101 using a mobile device mount coupled to the hand element of the wearable data collection device. The mobile device is positioned in a backward-facing orientation, wherein the camera of the mobile device faces away from the finger elements of the wearable data collection device. This backward-facing orientation positions the camera to capture image data of the environment behind the wearable data collection device, which may include the wearer of the device. This configuration may provide superior position tracking accuracy in some scenarios compared to forward-facing orientations by capturing more stable reference points in the surrounding environment, which is particularly advantageous in environments with variable lighting conditions or limited visual features in the manipulation workspace.

The mobile device mount is designed to securely hold the mobile device in this backward-facing orientation throughout the recording session, ensuring consistent positioning for accurate tracking. The mount may incorporate features such as adjustable clamps, non-slip surfaces, and/or locking mechanisms to maintain a secure connection between the mobile device and the wearable data collection device, preventing undesired movement or misalignment during manipulation tasks.

The operations of process 700 further include capturing sensor data via a plurality of sensors on the data collection device (step 703). In the example of FIG. 1, data collection device 101 captures data from various sensors as described previously. These sensors may include pressure sensors positioned on each finger element, position sensors at the joints to capture angle data, cameras mounted on the data collection device to provide visual data, time-of-flight sensors for distance measurements, and piezoelectric microphones to detect contact sounds. The sensor data captures comprehensive information about the manipulation tasks being performed by the user while wearing the data collection device.

The operations of process 700 further include capturing position and orientation data with the mobile device (step 705). In the example of FIG. 1, position tracking module 119 on external device 117 (implemented as a mobile device) tracks the movements of data collection device 101 through space during the recording session. This tracking may utilize the mobile device's inertial measurement unit (IMU), camera, and/or SLAM (Simultaneous Localization and Mapping) algorithms to calculate the position and orientation of the wearable data collection device relative to the environment. The backward-facing orientation of the mobile device's camera provides a consistent view of the environment behind the device, which typically contains more stable reference points for tracking than the manipulation workspace in front of the device.

The backward-facing mobile device may capture environmental image data that provides contextual information about the surroundings during the recording session. This information can be valuable for understanding the context of the manipulation tasks and may be used during the training process to improve the robotic control model's ability to adapt to different environmental conditions. While the primary purpose of the backward-facing orientation is to improve position tracking accuracy, the environmental context captured by the camera can serve as an additional source of useful training data.

The operations of process 700 further include transmitting the sensor data to the mobile device (step 707). In the example of FIG. 1, device circuitry 115 transmits the processed sensor data to external device 117 (the mobile device). This transmission may occur via a connection interface, which could be a wired connection such as USB or a wireless connection such as Bluetooth, Wi-Fi, or similar protocols. The connection interface enables the sensor data collected by the wearable data collection device to be combined with the position and orientation data captured by the mobile device, creating a comprehensive dataset that describes both the manipulation actions and the spatial trajectory of these actions.

The mobile device receives the sensor data through its corresponding interfaces and may further process, display, or store the information using data collection application 121. Data collection application 121 may provide user interfaces for monitoring the data collection process, visualizing sensor readings in real-time, managing the transfer of collected data to training system 125, and the like. The application may also implement data validation routines, quality assessments, and/or annotation capabilities to enhance the usefulness of the collected data for training purposes.

The combined sensor data and position information is eventually transmitted from the mobile device to training system 125 via network interface 123. This data serves as the foundation for training a neural network that will control the robotic counterpart device, enabling it to replicate the manipulation strategies demonstrated by the user while wearing the data collection device. The position and orientation data provided by the backward-facing mobile device is particularly valuable for training the neural network to understand spatial relationships and movement trajectories during manipulation tasks.

The configuration shown in FIG. 7 and described above represents just one example implementation of a process for utilizing a mobile device with a wearable data collection device. The specific mobile device technologies, mounting configurations, tracking algorithms, connection interfaces, and data processing methods may vary while remaining within the scope of the present disclosure. For instance, the mobile device might utilize different tracking technologies, operate with various camera configurations, or employ alternative algorithms for position estimation. The connection interface might implement different communication protocols or data transfer mechanisms. These variations and others not explicitly described are contemplated as part of the present technology.

FIG. 8 illustrates process 800. Process 800 is an exemplary operation of using an augmented reality (AR) headset with a wearable data collection device to track position and orientation during recording sessions. The operations may vary in other examples. The operations of process 800, in some examples, are performed by data collection device 101 in the example of FIG. 1, in conjunction with external device 117 implemented as an AR headset system, and/or by wearable data collection device 300. Process 800 may be implemented in program instructions in the context of the software and/or firmware elements of device circuitry 115 and/or data collection application 121. The program instructions, when executed by processing circuitry of the relevant devices, direct the devices to operate as follows, referring to the steps of FIG. 8.

The operations of process 800 include initiating a recording session in response to a user input (step 801). In the example of FIG. 1, a user provides input to initiate data collection, which may be received through the AR headset interface, through start/stop interface 113 on data collection device 101, or through other input mechanisms. Unlike mobile device implementations where the user might interact directly with a phone screen, the AR headset interface provides a spatial, three-dimensional user experience that can present information and controls within the user's visual field. The AR headset may display virtual interface elements, accept voice commands, utilize eye tracking for selection, or detect specific hand gestures to initiate recording sessions. This hands-free interaction capability is particularly advantageous when the user's hands are occupied with wearing and operating the data collection device.

The operations of process 800 further include tracking position and orientation of the data collection device with an AR controller (step 803). In the example of FIG. 1, an AR headset system that includes external device 117 tracks the position and orientation of data collection device 101 via an associated controller that is secured to the wearable data collection device. As shown in FIGS. 3A-31, controller 333 may be mechanically mounted to wearable data collection device 300 such that it moves in coordination with the device. The AR headset utilizes its built-in tracking systems, which may include infrared cameras, computer vision algorithms, or other spatial tracking technologies, to monitor the position of controller 333. Since controller 333 is physically bound to the wearable data collection device, the AR headset can accurately determine the position and orientation of the entire data collection device throughout the recording session.

This tracking approach leverages the AR headset's native capabilities for spatial awareness and object tracking, which are optimized for low-latency, high-precision operation. AR headsets typically employ sophisticated tracking algorithms that combine multiple sensor inputs, such as inertial measurement units, cameras, and/or depth sensors, to maintain accurate position estimates even in challenging conditions. The use of an AR controller as an intermediary tracking element provides a robust connection between the data collection device and the headset's tracking system to provide consistent and reliable position data throughout the recording session.

The operations of process 800 further include capturing sensor data via a plurality of sensors on the data collection device (step 805). In the example of FIG. 1, data collection device 101 captures data from various sensors as described previously. These sensors may include pressure sensors positioned on each finger element, position sensors at the joints to capture angle data, cameras mounted on the data collection device to provide visual data, time-of-flight sensors for distance measurements, piezoelectric microphones to detect contact sounds, and the like. The sensor data captures comprehensive information about the manipulation tasks being performed by the user while wearing the data collection device, providing multi-modal input that enables sophisticated learning of manipulation strategies.

Simultaneously with the sensor data collection from the wearable device, the AR headset may capture additional environmental data through its own sensors. AR headsets typically include high-resolution cameras, depth sensors, and other environmental sensing capabilities that can provide broader context about the manipulation environment. A camera mounted on the AR headset can capture visual data of the environment from the user's perspective, providing a wider field of view than cameras mounted on the wearable data collection device. This comprehensive environmental awareness, combined with the detailed sensor data from the wearable device, creates a rich dataset for training the neural network model.

The operations of process 800 further include transmitting the sensor data to the AR headset (step 807). In the example of FIG. 1, device circuitry 115 transmits the processed sensor data to external device 117 (the AR headset). This transmission may occur via a connection interface, which could be a wired connection such as USB or a wireless connection such as Wi-Fi, Bluetooth, or proprietary wireless protocols specific to the AR headset system. The connection interface enables the sensor data collected by the wearable data collection device to be combined with the position and orientation data captured by the AR headset, as well as any additional environmental data captured by the headset's own sensors.

The AR headset receives the sensor data through its corresponding interfaces and may utilize data collection application 121 or similar software to process, display, and manage the information. In the AR environment, this data can be visualized in innovative ways, such as displaying real-time sensor readings as virtual overlays, showing graphical representations of forces and movements, or providing immediate feedback about data quality and collection progress. The immersive nature of AR enables more intuitive monitoring and control of the data collection process compared to traditional screen-based interfaces.

The operations of process 800 further include terminating the recording session in response to a second user input (step 809). Similar to the initiation step, the termination of the recording session can be accomplished through various interaction modalities available in the AR environment. The user may provide voice commands, use eye tracking to select a virtual stop button, perform predefined hand gestures, interact with start/stop interface 113 on the data collection device, or the like. The AR headset may confirm the termination of the recording session and ensure all collected data, including sensor data from the wearable device, position and orientation data from the controller tracking, and any environmental data captured by the headset, is properly stored and prepared for transmission to training system 125.

The combined dataset created through this process includes not only the traditional sensor data from the wearable data collection device but may also include head pose data from the AR headset, providing information about where the user was looking during manipulation tasks. This additional data can be valuable for understanding user attention patterns and visual strategies during object manipulation, potentially improving the training of neural networks for robotic control. The position and orientation data provided by the AR headset tracking system offers sub-millimeter accuracy in many implementations, significantly enhancing the precision of spatial information available for training the robotic counterpart device.

The configuration shown in FIG. 8 and described above represents just one example implementation of a process for utilizing an AR headset with a wearable data collection device. The specific AR headset technologies, controller configurations, tracking algorithms, connection interfaces, and data processing methods may vary significantly while remaining within the scope of the present disclosure. For instance, different AR headset platforms may utilize various tracking technologies such as SLAM-based systems, infrared beacon tracking, or magnetic field-based positioning. The controller interface might employ different mounting mechanisms or integrate alternative input modalities. The data visualization and interaction paradigms in the AR environment might implement various user experience approaches optimized for specific use cases. These variations and others not explicitly described are contemplated as part of the present technology.

FIG. 9 illustrates computing system 901 to perform data collection, training, and/or robotic control operations according to various implementations of the present technology. Computing system 901 is representative of any computing system or collection of systems with which the various operational architectures, processes, scenarios, and sequences disclosed herein for collecting training data and/or training robotic control models may be used. Computing system 901 may be implemented as a single apparatus, system, or device or may be implemented in a distributed manner as multiple apparatuses, systems, or devices. Examples of computing system 901 include, but are not limited to, wearable data collection devices, mobile devices used for position tracking, augmented reality headsets, desktop computers, laptop computers, server computers, cloud computing platforms, and data center equipment.

Computing system 901 includes storage system 903, communication interface system 907, user interface system 909, and processing system 902. Processing system 902 is linked to communication interface system 907 and user interface system 909. Storage system 903 stores and operates software 905, which includes training process 906. Computing system 901 may include other well-known components such as batteries and enclosures that are not shown in the present example for clarity.

Processing system 902 loads and executes software 905 from storage system 903. Software 905 includes and implements training process 906, which is representative of the data collection, training, and robotic control operations discussed with respect to the preceding figures. When executed by processing system 902 to perform the processes described herein, software 905 directs processing system 902 to operate as described for at least the various processes, operational scenarios, and sequences discussed in the foregoing implementations. Computing system 901 may optionally include additional devices, features, or functionality not discussed for purposes of brevity.

Referring still to FIG. 9, processing system 902 may include a micro-processor and other circuitry that retrieves and executes software 905 from storage system 903. Processing system 902 may be implemented within a single processing device but may also be distributed across multiple processing devices or sub-systems that cooperate in executing program instructions. Examples of processing system 902 include general purpose central processing units, graphical processing units, neural processing units, application specific processors, and logic devices, as well as any other type of processing devices, combinations, or variations thereof.

User interface system 909 includes components that interact with a user to receive user inputs and to present information. User interface system 909 may include a speaker, microphone, buttons, lights, display screen, touch screen, camera, start/stop interface, activation mechanism, or some other user input/output apparatus, including combinations thereof. In the context of the present technology, user interface system 909 may include specialized components such as pressure-sensitive activation mechanisms integrated into wearable data collection devices, voice recognition capabilities in AR headsets, spatial gesture recognition systems, or the like. User interface system 909 may be omitted in some examples.

Storage system 903 may include any computer-readable storage media readable by processing system 902 and capable of storing software 905. Storage system 903 may include volatile and nonvolatile, removable, and non-removable media implemented in any method or technology for storage of information, such as computer readable instructions, data structures, program modules, or other data. Examples of storage media include random access memory, read only memory, magnetic disks, optical disks, optical media, flash memory, virtual memory and non-virtual memory, magnetic cassettes, magnetic tape, magnetic disk storage or other magnetic storage devices, or any other suitable storage media. In no case is the computer-readable storage media a propagated signal.

In addition to computer-readable storage media, in some implementations storage system 903 may also include computer-readable communication media over which at least some of software 905 may be communicated internally or externally. Storage system 903 may be implemented as a single storage device but may also be implemented across multiple storage devices or sub-systems co-located or distributed relative to each other. Storage system 903 may include additional elements, such as a controller, capable of communicating with processing system 902 or possibly other systems.

Software 905 (including training process 906) may be implemented in program instructions and among other functions may, when executed by processing system 902, direct processing system 902 to operate as described with respect to the various operational scenarios, sequences, and processes illustrated herein. For example, software 905 may include program instructions for collecting sensor data from a wearable data collection device, processing the sensor data, training neural network models, and controlling robotic counterpart devices as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 905 may include additional processes, programs, or components, such as operating system software, virtualization software, or other application software. Software 905 may also include firmware or some other form of machine-readable processing instructions executable by processing system 902.

In general, software 905 may, when loaded into processing system 902 and executed, transform a suitable apparatus, system, or device (of which computing system 901 is representative) overall from a general-purpose computing system into a special-purpose computing system customized to perform data collection, model training, and/or robotic control functionality as described herein. Indeed, encoding software 905 on storage system 903 may transform the physical structure of storage system 903. The specific transformation of the physical structure may depend on various factors in different implementations of this description. Examples of such factors may include, but are not limited to, the technology used to implement the storage media of storage system 903 and whether the computer-storage media are characterized as primary or secondary storage, as well as other factors.

Communication interface system 907 may include communication connections and devices that allow for communication with other computing systems (not shown) over communication networks (not shown). Examples of connections and devices that together allow for inter-system communication may include network interface cards, ports, antennas, power amplifiers, radio frequency (RF) circuitry, transceivers, and other communication circuitry. The connections and devices may communicate over communication media to exchange communications with other computing systems or networks of systems, such as metal, glass, air, or any other suitable communication media. Communication interface system 907 may be configured to use Time Division Multiplex (TDM), Internet Protocol (IP), Ethernet, optical networking, wireless protocols, communication signaling, or some other communication format, including combinations thereof. The aforementioned media, connections, and devices are well known and need not be discussed at length here.

For example, if the computer readable storage media are implemented as semiconductor-based memory, software 905 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication between computing system 901 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

The techniques introduced herein may be embodied as special-purpose hardware (e.g., circuitry), as programmable circuitry appropriately programmed with software and/or firmware, or as a combination of special-purpose and programmable circuitry. Hence, embodiments may include a machine-readable medium having stored thereon instructions which may be used to program a computer (or other electronic devices) to perform a process. The machine-readable medium may include, but is not limited to, optical disks, compact disc read-only memories (CD-ROMs), magneto-optical disks, ROMs, random access memories (RAMs), erasable programmable read-only memories (EPROMs), electrically erasable programmable read-only memories (EEPROMs), magnetic or optical cards, flash memory, or other types of media or machine-readable medium suitable for storing electronic instructions.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or,” in reference to a list of two or more items, covers all of the following interpretations of the word: any of the items in the list, all of the items in the list, and any combination of the items in the list.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

The above Detailed Description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further, any specific numbers noted herein are only examples: alternative implementations may employ differing values or ranges.

The teachings of the technology provided herein can be applied to other systems, not necessarily the system described above. The elements and acts of the various examples described above can be combined to provide further implementations of the technology. Some alternative implementations of the technology may include not only additional elements to those implementations noted above, but also may include fewer elements.

These and other changes can be made to the technology in light of the above Detailed Description. While the above description describes certain examples of the technology, no matter how detailed the above appears in text, the technology can be practiced in many ways. Details of the system may vary considerably in its specific implementation, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the technology to the specific examples disclosed in the specification, unless the above Detailed Description section explicitly defines such terms. Accordingly, the actual scope of the technology encompasses not only the disclosed examples, but also all equivalent ways of practicing or implementing the technology under the claims.

To reduce the number of claims, certain aspects of the technology are presented below in certain claim forms, but the applicant contemplates the various aspects of the technology in any number of claim forms. For example, while only one aspect of the technology is recited as a computer-readable medium claim, other aspects may likewise be embodied as a computer-readable medium claim, or in other forms, such as being embodied in a means-plus-function claim. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application to pursue such additional claim forms, in either this application or in a continuing application.

What is claimed is:

1. A wearable data collection device comprising:
a hand element configured to receive a hand of a user;
a plurality of finger elements extending from the hand element;
a time-of-flight sensor mounted on the wearable data collection device, wherein the time-of-flight sensor comprises:
a light emitter configured to emit light;
a grid of light receivers configured to detect reflections of the light; and
circuitry configured to collect time-of-flight data representing time between emission of the light and detection of the reflections at the grid of light receivers; and
a processing circuit operatively coupled to the time-of-flight sensor configured to collect and transmit the time-of-flight data.

2. The wearable data collection device of claim 1, further comprising a second time-of-flight sensor mounted at a different location on the wearable data collection device.

3. The wearable data collection device of claim 2, further comprising at least two cameras mounted on the wearable data collection device, wherein the time-of-flight sensor and the second time-of-flight sensor are each positioned proximate to a respective one of the at least two cameras.

4. The wearable data collection device of claim 1, further comprising a bevel surrounding the time-of-flight sensor, wherein the bevel is configured to control an angular distribution of the light emitted and received by the time-of-flight sensor.

5. The wearable data collection device of claim 1, wherein the grid of light receivers comprises an eight-by-eight grid of receivers, and wherein the time-of-flight data comprises sixty-four individual time measurements.

6. The wearable data collection device of claim 1, wherein the time-of-flight sensor is positioned on a finger element of the plurality of finger elements and oriented to emit the light toward an object being manipulated with the wearable data collection device.

7. The wearable data collection device of claim 1, further comprising:
a plurality of sensors mounted on the wearable data collection device configured to capture sensor data during a recording session, wherein the plurality of sensors includes:
at least one pressure sensor positioned on each finger element of the plurality of finger elements; and
at least one position sensor at each joint of a plurality of joints that couple the plurality of finger elements to the hand element; and
wherein the time-of-flight data and the sensor data captured during the recording session are configured to be used to train a neural network that controls a robotic counterpart device having a joint and sensor configuration that matches the wearable data collection device.

8. A method of collecting training data using a wearable data collection device, the method comprising:
emitting light from at least one time-of-flight sensor mounted on the wearable data collection device;
detecting reflections of the light at a grid of light receivers of the at least one time-of-flight sensor;
collecting time-of-flight data representing time between emission of the light and detection of the reflections at the grid of light receivers; and
processing and transmitting the time-of-flight data via a processing circuit operatively coupled to the at least one time-of-flight sensor.

9. The method of claim 8, wherein the at least one time-of-flight sensor comprises two time-of-flight sensors positioned at different locations on the wearable data collection device, and wherein collecting the time-of-flight data comprises collecting data from each of the two time-of-flight sensors.

10. The method of claim 9, further comprising capturing visual data using at least two cameras mounted on the wearable data collection device, wherein each of the two time-of-flight sensors is positioned proximate to a respective one of the at least two cameras.

11. The method of claim 8, wherein the at least one time-of-flight sensor is surrounded by a bevel, and wherein the bevel defines a field of view angle for the at least one time-of-flight sensor.

12. The method of claim 8, wherein the grid of light receivers comprises an eight-by-eight grid of receivers, and wherein collecting the time-of-flight data comprises collecting sixty-four individual time measurements.

13. The method of claim 8, further comprising:
initiating a recording session in response to a first user input received via an activation mechanism on the wearable data collection device;
manipulating an object with the wearable data collection device during the recording session, wherein the at least one time-of-flight sensor is positioned on at least one finger element of a plurality of finger elements of the wearable data collection device and oriented to emit the light toward the object during manipulation; and
terminating the recording session in response to a second user input received via the activation mechanism.

14. The method of claim 8, further comprising:
capturing sensor data during a recording session using a plurality of sensors mounted on the wearable data collection device, wherein the plurality of sensors includes:
at least one pressure sensor positioned on each finger element of a plurality of finger elements of the wearable data collection device; and
at least one position sensor at each of a plurality of joints that couple the plurality of finger elements to a hand element of the wearable data collection device; and
providing the time-of-flight data and the sensor data as training data to a neural network configured to control a robotic counterpart device.

15. A method of training a robotic control model, the method comprising:
receiving time-of-flight data captured during a recording session by at least one time-of-flight sensor mounted on a wearable data collection device, wherein:
the wearable data collection device comprises a hand element configured to receive a hand of a user and a plurality of finger elements extending from the hand element; and
the at least one time-of-flight sensor comprises a light emitter, a grid of light receivers, and circuitry configured to collect the time-of-flight data representing time between emission of light and detection of reflections at the grid of light receivers;
processing the time-of-flight data to generate training data for a neural network; and
training the neural network using the training data to generate a trained neural network model, wherein the trained neural network model is configured to control a robotic counterpart device having a sensor configuration that includes at least one time-of-flight sensor corresponding to the at least one time-of-flight sensor of the wearable data collection device.

16. The method of claim 15, wherein controlling the robotic counterpart device with the trained neural network model comprises:
receiving real-time time-of-flight data from at least one time-of-flight sensor on the robotic counterpart device;
processing the real-time time-of-flight data using the trained neural network model to determine control signals; and
transmitting the control signals to the robotic counterpart device to control movement of the robotic counterpart device.

17. The method of claim 15, further comprising:
receiving additional sensor data captured during the recording session by a plurality of sensors mounted on the wearable data collection device, wherein the plurality of sensors includes:
at least one pressure sensor positioned on each finger element of the plurality of finger elements; and
at least one position sensor at each of a plurality of joints that couple the plurality of finger elements to the hand element; and
incorporating the additional sensor data with the time-of-flight data to generate the training data for the neural network.

18. The method of claim 15, wherein:
the at least one time-of-flight sensor comprises two time-of-flight sensors positioned at different locations on the wearable data collection device; and
the time-of-flight data comprises data collected from each of the two time-of-flight sensors.

19. The method of claim 15, wherein the grid of light receivers comprises an eight-by-eight grid of receivers, and wherein the time-of-flight data comprises sixty-four individual time measurements for each instance of data collection during the recording session.

20. The method of claim 15, further comprising:
receiving additional time-of-flight data from multiple recording sessions from the wearable data collection device, wherein the multiple recording sessions comprise recordings of different tasks performed with the wearable data collection device;
analyzing the additional time-of-flight data to identify one or more patterns associated with distance measurements to objects being manipulated; and
refining the trained neural network model based on the one or more patterns to improve object manipulation capabilities of the robotic counterpart device.
